(19) United States
(12) Patent Application Publication
(10) Pub. No.: US 2026/0346817 A1
(43) Pub. Date: Nov. 5, 2026

(54) PEDAL DEVICE

(71) Applicant: BOGE Elastmetall GmbH, Damme (DE)

(72) Inventors: Daniel Häffelin, Langenargen (DE); Slawomir Bakaus, Bad Honnef (DE); Olaf Beutler, Vechta (DE); Ulrich Bladt, Ibbenbüren (DE); Alexander Hessling, Ruppichteroth (DE)

(21) Appl. No.: 19/486,699

(22) PCT Filed: Mar. 11, 2024
(86) PCT No.: PCT/EP2024/056312

§ 371 Date: Nov. 21, 2025

(30) Foreign Application Priority Data
May 23, 2023 (DE) 10 2023 113 500.7

(51) Int. Cl. B60T 7/06; G05G 1/38; G05G 5/05

(52) U.S. Cl. CPC B60T 7/06; G05G 1/38; G05G 5/05

(57) ABSTRACT

A pedal device includes a pedal, a pedal holder, at least one pedal spring, and a spring means. The pedal having a pedal body and a pedal cap arranged at an end of the pedal body and provided with a tread area which forms a free end of the pedal. The pedal body is movably mounted in an axial direction on the pedal holder. The at least one pedal spring is installed between the pedal holder and the pedal body and against whose spring force the pedal body can move in the axial direction relative to the pedal holder. The spring means is provided between the tread area and the pedal body, against whose spring force the step area can move in the axial direction relative to the pedal body.

### CROSS-REFERENCE TO RELATED APPLICATIONS

The present application is the U.S. National Phase entry of International Patent Application No. PCT/EP2024/056312 filed Mar. 11, 2024, which claims priority to German Patent Application No. 10 2023 113 500.7 filed May 23, 2023, the entire contents of which are incorporated herein by reference.

### TECHNICAL FIELD

The present disclosure relates to a pedal device with a pedal, which comprises a pedal body and a pedal cap, which is arranged at one end of the pedal body and is provided with a tread area that forms a free end of the pedal, a pedal holder on which the pedal body is mounted in a manner allowing axial movement, and at least one pedal spring that is interposed between the pedal holder and the pedal body, enabling the pedal body to move axially relative to the pedal holder against the spring force towards the pedal holder.

### BACKGROUND

DE 198 36 691 A1 discloses a pedal device for electrically actuated motor vehicle brakes, with a pedal body which can be moved in the actuation direction in translational motion, which is under the force of a spring counteracting the actuation direction as a return means, which preferably has a linear characteristic curve. The pedal body has an attachment means which converts at least one linearly increasing actuation travel increment into progressively increasing spring travel increments and imparts the travel increments to the adjacent spring, wherein a cam with a defined, non-linear cam profile is provided as an attachment means. At the foot end, the pedal body comprises a thickened cap on which a shaft is connected, the end of the shaft being subjected to a return spring.

The disadvantage of known linear pedal devices with electronic pedal actuation detection is that the spring travel of the return spring is short and its spring rigidity is large. On the one hand, this serves to keep the pedal assembly as a whole compact, on the other hand, the sensors used for electronic pedal actuation detection generally have a short detection path. However, the resulting short pedal travel can lead to irritation for the driver, as he is used to conventional, swivelling pedals with relatively long pedal travel.

In this context, the object of the present disclosure is in particular to increase the pedal travel of a linear pedal device, while still maintaining a compact design.

### SUMMARY

Accordingly, this object is achieved with a pedal device according to the present disclosure.

A pedal device comprising a pedal that includes a pedal body and a pedal cap arranged at one end of the pedal body, featuring a tread area that forms the free end of the pedal, a pedal holder on which the pedal body is mounted for axial movement, and at least one pedal spring that is positioned between the pedal holder and the pedal body and against the spring force of which the pedal body can move axially relative to the pedal holder, towards the pedal holder, and a spring mechanism provided between the tread area and the pedal body, allowing the tread area to move axially relative to the pedal body against the spring force, in embodiments, towards the pedal body.

The spring mechanism is connected in series to the at least one pedal spring. This results, for example, in a lower spring stiffness and/or increased pedal travel between the tread area and the pedal holder. Furthermore, by incorporating the spring mechanism between the tread area and the pedal body, an increase in the size of the pedal bracket, which is typically designed as a housing, can be avoided. It is also possible to integrate the spring element into the pedal cap. The compactness of the pedal assembly can thus be preserved.

In embodiments, a longitudinal axis extending in the axial direction is assigned to the pedal body and/or the at least one pedal spring, which runs centrally through the pedal body and/or through the at least one pedal spring. One or any direction transverse to the longitudinal axis and/or transverse to the axial direction is in particular referred to as the radial direction. In embodiments, a direction running around the longitudinal axis is referred to as a circumferential direction. The expression “at least one” also has the meaning of “one” or “exactly one”.

In embodiments, the pedal body extends in the axial direction. In embodiments, the pedal body is elongated in the axial direction. In embodiments, the pedal body is a tube or a rod. The pedal body can also be referred to as a shaft, for example. The end of the pedal body on which the pedal cap is arranged is in particular also referred to as the pedal cap-side end of the pedal body. In embodiments, the pedal cap-side end of the pedal body is an axial end of the pedal body. In embodiments, the end of the pedal body on the pedal cap side is an end of the pedal body facing away from the pedal holder. In embodiments, the pedal cap is firmly connected to the pedal body and/or to the pedal cap-side end of the pedal body. The pedal body is in particular a dimensionally stable body. For example, the pedal body is a rigid body. In embodiments, the pedal body is made of plastic and/or metal. For example, the pedal body is displaceably guided on the pedal holder in an axial direction. In embodiments, an axial position of the pedal body that is set when the pedal device is not actuated is in particular referred to as the pedal body rest position.

In embodiments, the pedal holder is a housing, which can also be referred to as a pedal housing, for example. In particular, the pedal holder comprises an interior. In embodiments, the at least one pedal spring is arranged in the pedal holder and/or in the interior thereof. In embodiments, the pedal body extends into the pedal holder and/or into its interior. In embodiments, the pedal cap and/or the pedal cap-side end of the pedal body is provided outside the pedal holder and/or the interior thereof. In particular, the pedal holder is a dimensionally stable body. For example, the pedal holder is a rigid body. In embodiments, the pedal holder is made of plastic and/or metal. In embodiments, the pedal holder is cylindrical, in particular at least in some regions. For example, the pedal holder is pot-shaped.

In embodiments, the pedal body is mounted on the pedal holder in such a way that it can move axially, supported by the at least one pedal spring. In embodiments, the pedal body is movably guided by the at least one pedal spring in an axial direction, in particular on or in the pedal holder. For example, the movability of the pedal body, in particular through the at least one pedal spring means, is limited to only one dimension, in embodiments, relative to the pedal holder. This dimension is given in particular by the axial direction.

The at least one pedal spring does not comprise, for example, a coil spring. In embodiments, the at least one pedal spring comprises at least one or more flat springs, in embodiments, planar, oriented transversely to the axial direction, which are penetrated by the pedal body and provide spring support on the pedal holder, particularly in the axial direction, or is formed in this way, for example. In embodiments, the number of flat springs is two or at least two. In particular, each flat spring is planar. In embodiments, the flat springs are of identical design. In embodiments, each flat spring lies or runs, in particular in the non-tensioned state, in a flat spring plane that runs transversely to the axial direction. The flat springs can be used, for example, to implement small spring-loaded axial movement paths of the pedal body relative to the pedal holder. For example, the, in particular maximum and/or free, spring travel of the at least one pedal spring and/or the flat springs is 3 mm, 5 mm or 3 mm to 5 mm. In embodiments, each flat spring is made of metal, in particular spring steel. Alternatively, each flat spring is made of plastic, for example. In embodiments, each flat spring has a central through-hole through which in particular the pedal body extends. In embodiments, each flat spring is penetrated by the pedal body, wherein the latter extends through its central through-hole. For example, each flat spring forms a spring washer. In embodiments, the pedal body is resiliently supported and/or guided on the pedal holder by the at least one pedal spring and/or by flat springs, particularly in the axial direction. The flat spring or the flat springs enable, for example, a particularly compact design of the pedal assembly. In embodiments, the pedal body is mounted on the pedal holder in such a way that it can be moved axially by the at least one flat spring or by the flat springs.

In embodiments, the flat springs are connected in parallel. In embodiments, the pedal body is connected to the pedal holder, in particular resiliently, via the or a parallel connection of the flat springs. In embodiments, the pedal body is movable against the spring force of the or a parallel connection of the flat springs, in particular starting from the or a pedal body rest position, in the axial direction relative to the pedal holder.

In embodiments, the flat springs are arranged one behind the other in the axial direction and at a distance from one another. An axial guidance of the pedal body can thus particularly be achieved by the at least one pedal spring and/or by the flat springs. In embodiments, each flat spring has a plurality of, in particular three or at least three, spring webs which are spaced apart and/or separated from each other in the circumferential direction, in particular at least in regions, and which are arranged, in particular evenly distributed, in particular around the bearing element. In embodiments, the spring webs of each flat spring extend or run, in particular transversely to the axial direction, between the pedal body and the pedal holder and/or from the pedal body up to the pedal holder. The spring webs are also referred to as spring leaves, for example. In particular, the spring webs of each flat spring extend or run in their respective flat spring plane. In embodiments, the pedal body is resiliently supported on the pedal holder by or by interconnection of the spring webs, in embodiments, at a, in particular radial, distance from the pedal body, in particular in the axial direction. As a result, the pedal body is, for example, resiliently supported on the pedal holder, in particular by the at least one spring means and/or by the flat springs, in particular in the axial direction.

In embodiments, each spring web has an outer and/or free spring web end which in particular faces away from the pedal body and/or faces the pedal holder, and which is in particular a radially outer spring web end. For example, each flat spring is attached to or in the housing with its outer and/or free spring bar ends. In embodiments, each spring web has an inner spring web end which in particular faces the pedal body and/or faces away from the pedal holder, and which is in particular a radially inner spring web end. For example, each flat spring is fastened to the pedal body with its inner spring web ends.

In embodiments, each flat spring has an outer frame, in particular rigidly connected to its spring webs and/or to its outer and/or free spring bar ends. In embodiments, the spring web of each flat spring extend from their outer frame in the direction of the pedal body. The outer frame of each flat spring is in particular ring-shaped or a ring and is also referred to as an outer ring, for example. In embodiments, each flat spring, in particular on its outer circumference and/or with its outer frame, is attached to the pedal holder. In embodiments, each flat spring, in particular on its outer circumference and/or with its outer frame, engages in one or at least one groove which is provided on the inner circumference of the pedal holder, and which, in embodiments, is an annular groove. In embodiments, each flat spring and/or the outer frame of each flat spring has a round and/or circular outer circumferential contour.

In embodiments, each flat spring has an inner frame, in particular firmly connected to its spring webs and/or to its inner spring web ends. In particular, the inner frame of each flat spring limits its central through-hole. In embodiments, the inner frame surrounds or encircles the pedal body. The pedal body extends in particular through the inner frame. For example, the inner frame of each flat spring is penetrated by the pedal body. In embodiments, the spring webs of each flat spring extend from their inner frame towards the pedal holder and/or towards the respective outer frame. In embodiments, the spring bars are arranged around the inner frame, in particular evenly distributed. The inner frame of each flat spring is in particular ring-shaped or a ring and is also referred to as an inner ring, for example. In embodiments, each flat spring is firmly seated with its inner frame on the pedal body, in particular penetrating it. In embodiments, each flat spring, in particular on its inner circumference and/or with its inner frame, is fastened to the pedal body. In embodiments, each flat spring, in particular on its inner circumference and/or with its inner frame, engages in one or at least one groove which is provided on the outer circumference of the pedal body, and which, in embodiments, is an annular groove. In embodiments, each flat spring and/or the inner frame of each flat spring has a round and/or circular inner circumferential contour.

In embodiments, the outer frame of each flat spring surrounds or encircles its inner frame, in embodiments, at a, in particular radial, distance. In embodiments, the spring webs of each flat spring extend from their inner frame to their outer frame.

In embodiments, each spring web or each spring web of each flat spring, in particular within its flat spring plane, is or runs, for example, angularly and/or bent and/or curved once or repeatedly. In embodiments, each spring web or each spring web of each flat spring, in particular within its flat spring plane, is or runs bent back and forth and/or in an S-shape. In particular, a linear behaviour and/or a linear characteristic curve can be achieved with spring webs shaped in this way. In embodiments, for example, each spring web or each spring web of each flat spring, in particular within its flat spring plane, runs straight, transversely to the axial direction. For example, straight spring webs such as these can be used to achieve a progressive behaviour and/or a progressive characteristic curve.

According to a further development, a pedal plate is provided at the end of the pedal body on the pedal cap side. In embodiments, the pedal plate is firmly and/or rigidly connected to the pedal body. For example, the pedal plate is positively and/or materially connected to the pedal body. In embodiments, the pedal plate is welded to the pedal body. In particular, the pedal plate is assigned to the pedal body. In embodiments, the pedal plate is aligned transversely to the axial direction and/or has, for example, a plate plane running transversely to the axial direction. In particular, the pedal plate is a dimensionally stable body. For example, the pedal plate is a rigid body. In embodiments, the pedal plate is made of plastic and/or metal. In embodiments, the pedal cap is positioned, in particular firmly, on the pedal plate. In embodiments, the pedal cap is firmly connected to the pedal plate. In embodiments, the spring means is provided between the tread area and the pedal plate.

According to one embodiment, the pedal cap is made of a flexible material, in particular at least partially or entirely. For example, the flexible material is an elastomer or a soft plastic. In embodiments, the pedal cap is elastically deformable. For example, the spring means is integrated into the pedal cap. In embodiments, the tread area of the pedal cap has several axial protrusions and/or a profiling on its outer side facing away from the pedal body and/or the pedal plate. These protrusions and/or this profiling counteract, for example, slipping of the driver's foot when the pedal is pressed.

According to a further development, a cavity is provided and/or formed in the pedal cap. In embodiments, the pedal cap confines and/or encloses the, or a, cavity, particularly either completely or at least partially. In embodiments, the pedal cap, together with the pedal body and/or the pedal plate, defines and/or encloses the, or a, cavity. In embodiments, a cavity is provided between the tread area and the pedal body and/or between the tread area and the pedal plate. In particular, the spring means is provided and/or arranged in the cavity.

According to a first variant, the spring means is formed, for example, by at least one solid body, particularly one that is introduced into the cavity. For example, the spring means is formed by a foam or foam material, in particular that is introduced into the cavity. In embodiments, the spring means may have, for example, one or more flexible projections extending into the cavity, which maintain a distance from one another. In embodiments, the spring means is formed by one or more flexible projections extending into the cavity, which maintain a distance from one another. In embodiments, the flexible projections are made from the material of the pedal cap. In embodiments, the projections extend in an axial direction and can for example also be referred to as axial projections. The projections extend, for example, starting from the tread area in the direction of the pedal body and/or the pedal plate. In embodiments, the projections taper with increasing, in particular axial, distance to the tread area. For example, the projections abut the pedal body and/or the pedal plate with their ends facing away from the tread area. In particular, a gas, such as air, is provided in the cavity between the projections.

According to a second variant, the cavity is, for example, a closed, in embodiments, gas-tight, space filled with a gas. In this case, the spring means is in particular formed by the gas trapped in the cavity. For example, the spring means forms a gas spring or gas pressure spring.

According to one configuration, the pedal cap is provided with a wall region encircling the cavity. The wall region is in particular flexible and/or elastically deformable. In embodiments, the wall region transitions at an axial end into the tread region. In embodiments, the wall region transitions at one, in particular other, axial end into a fastening region. In embodiments, the pedal cap is fastened with the fastening region to the pedal body and/or to the pedal plate. In embodiments, the fastening region encircles the pedal body and/or around the pedal plate.

According to a further development, at least one groove, in embodiments, extending around the pedal body and/or the pedal plate, is provided on the inner side of the fastening region facing the pedal body and/or the pedal plate, in which groove the pedal body, in particular with at least one engagement element protruding transversely to the axial direction, and/or the pedal plate, in particular with its edge, in embodiments, engages at least indirectly. For example, the pedal plate and/or its edge forms the engagement element.

According to one embodiment, a position detection device is provided, by which a current axial position of the pedal and/or the pedal body, in particular relative to the pedal holder, can be detected and at least one position signal characterising this position can be provided.

### BRIEF DESCRIPTION OF THE DRAWINGS

The present disclosure is described below based on embodiments with reference to the drawings. In the drawings:

FIG. 1 is a schematic sectional view of a pedal device according to a first embodiment,

FIG. 2 is a schematic sectional view of a pedal device according to a second embodiment,

FIG. 3 is a schematic sectional view of a pedal device according to a third embodiment,

FIG. 4 a schematic representation of several characteristic curves, and

FIG. 5 a top view of a flat spring.

### DETAILED DESCRIPTION

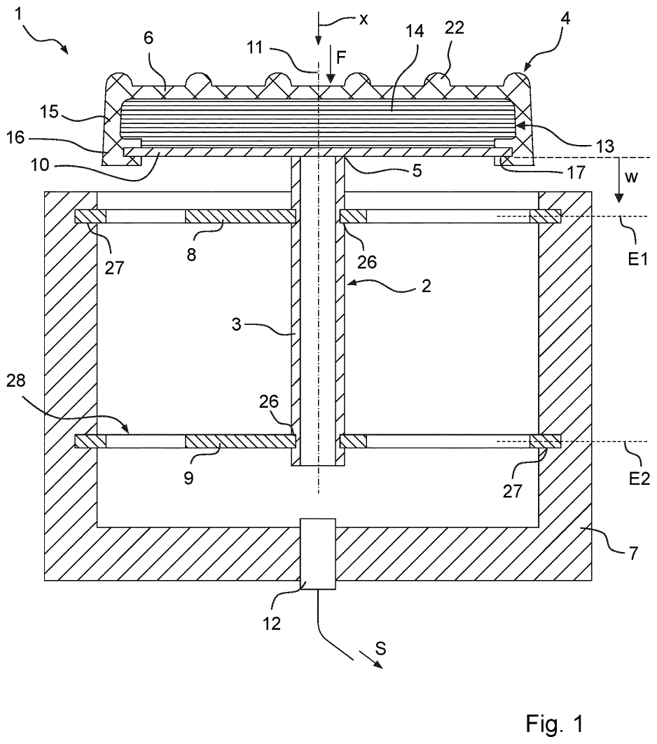

FIG. 1 shows a pedal device 1 according to a first embodiment, wherein the pedal device 1 comprises a pedal 2, which includes of a pedal body 3 and a pedal cap 4, which is arranged at a pedal cap-side end 5 of the pedal body 3 and features a tread area 6 that forms a free end of the pedal 2, and additionally comprises a pedal holder 7 in the form of a pot-shaped housing, on which the pedal body 3 is mounted for axial movement in the direction x by at least one pedal spring 28 interposed between the pedal holder 7 and the pedal body 3, wherein the pedal body 3 can move in the axial direction x relative to the pedal holder 7 against the force of the pedal spring 28. A pedal plate 10, which is firmly connected to the pedal body 3 and is aligned transversely to the axial direction, on which plate the pedal cap 4 sits, is provided at the pedal cap-side end 5 of the pedal body 3. The at least one pedal spring 28 is formed here by two flat springs 8 and 9, aligned flat and perpendicular to the axial direction x, which are penetrated by the pedal body 3 and support it resiliently in the axial direction x on the pedal holder 7, while simultaneously serving to guide the pedal body 3. Alternatively, more than two flat springs or only one flat spring can be used. It is also possible to use another type of spring or springs for the at least one pedal spring 28. In embodiments, if the at least one pedal spring 28 comprises only one spring and/or another type of spring or springs, an additional guide element for the pedal body 3 is provided.

A longitudinal axis 11 extending in the axial direction x is assigned to the pedal body 3, which runs in particular centrally through the pedal body 3.

Furthermore, a position detection device 12 is provided, by which a current axial position of the pedal body 3 relative to the pedal holder 7 can be detected and at least one position signal S characterising this position can be provided.

The pedal cap 4 is made of a flexible material, and wherein a cavity 13 is formed located between the tread area 6 and the pedal plate 10, in which a spring means 14 is incorporated. The pedal cap 4 is thus elastically deformable. In particular, the tread area 6 is movable in the axial direction x relative to the pedal plate 10 against the spring force of the spring means 14, which is made of a foam material in accordance with the first embodiment.

The pedal cap 4 is provided with a wall region 15 running around the cavity 13, which transitions at one axial end into the tread area 6 and at another axial end into a fastening region 16, with which the pedal cap 4 is fastened to the pedal plate 10. For this purpose, at least one groove 17 is provided on the inner side of the fastening region 16 that faces the pedal plate 10, in which the edge of the pedal plate 10 engages. Furthermore, the tread region 6 on its outer side facing away from the pedal plate 10 is in particular provided with a plurality of protrusions 22.

In embodiments, the flat springs 8 and 9 are arranged one behind the other in the axial direction x and at a distance from one another. In embodiments, the flat springs each run in a flat spring plane, wherein the flat spring plane of the flat spring 8 is denoted by E1 and the flat spring plane of the flat spring 9 is denoted by E2. Each flat spring plane runs in particular transverse to the axial direction x. In embodiments, the flat springs 8 and 9 are identically constructed.

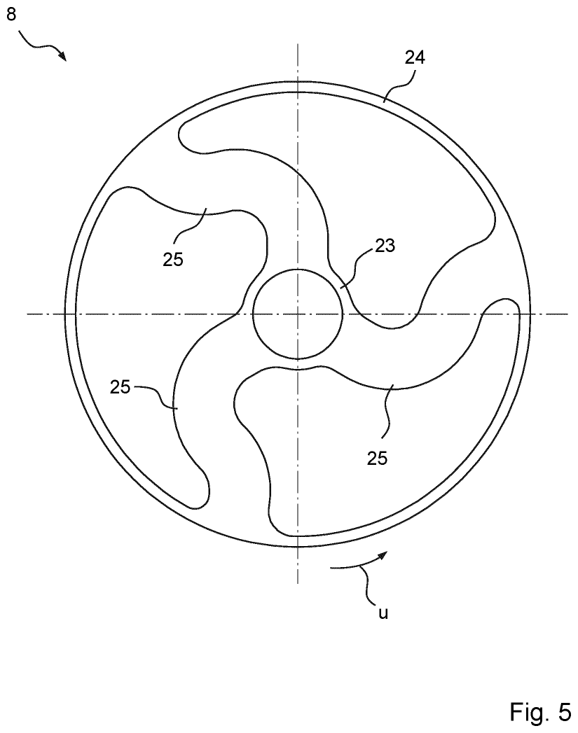

A first of the flat springs 8 is shown in a top view in FIG. 5 and has an inner ring 23, an outer ring 24 surrounding the inner ring, and several, in particular three, spring webs 25 arranged around the inner ring 23, which extend from the inner ring 23 to the outer ring 24 and are rigidly connected both to the inner ring 23 and to the outer ring 24. In this case, the spring webs 25 are arranged in an evenly distributed manner around the inner ring 23 and are in particular S-shaped in each case. The flat spring 9 is designed correspondingly.

In embodiments, each flat spring 8 and 9 are firmly seated with its inner ring 23 on the pedal body 3 and, for this purpose, engages with its inner ring 23 in an annular groove 26 provided on the outer circumference of the pedal body 3. Furthermore, each flat spring 8 and 9 are fastened to the pedal holder 7 with its outer ring 24 and, for this purpose, engages with its outer ring 24 in an annular groove 27 provided on the inner circumference of the pedal holder 7.

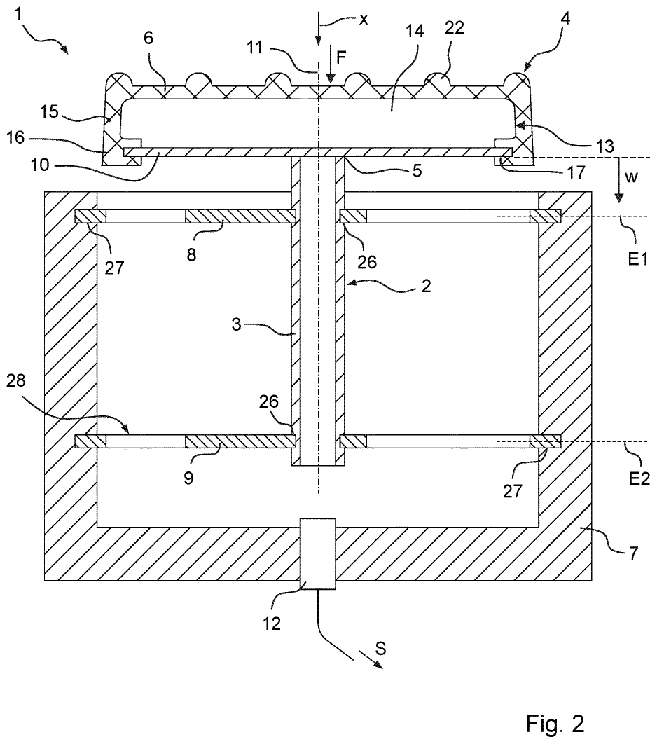

FIG. 2 shows a pedal device 1 according to a second embodiment, wherein features identical or similar to the first embodiment are denoted by the same reference numerals as in the first embodiment.

In contrast to the first embodiment, according to the second embodiment, the spring means 14 is formed by gas, such as air, trapped in the cavity 13.

Apart from this difference, the second embodiment corresponds the first embodiment, and for a more detailed description of the second embodiment, reference is made to the description of the first embodiment.

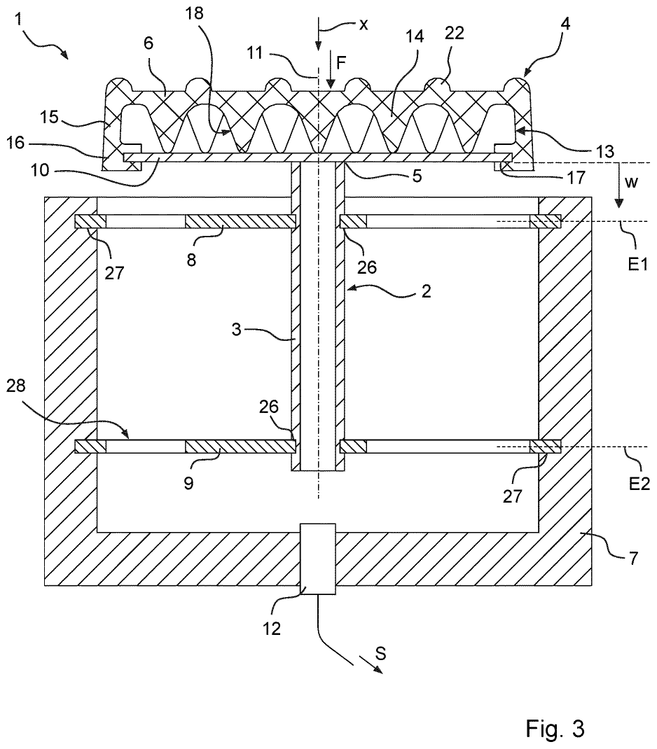

FIG. 3 shows a pedal device 1 according to a third embodiment, wherein features identical or similar to the first embodiment are denoted by the same reference numerals as in the first embodiment.

In contrast to the first embodiment, in the third embodiment the spring means 14 is formed by several flexible projections 18 that extend into the cavity 13, which are spaced apart from one another and are in particular made from the same material as the pedal cap 4. In particular, a gas, such as e.g. air, is provided in the cavity 13 between the projections.

Apart from these differences, the third embodiment corresponds to the first embodiment, and for a more detailed description of the third embodiment, reference is made to the description of the first embodiment.

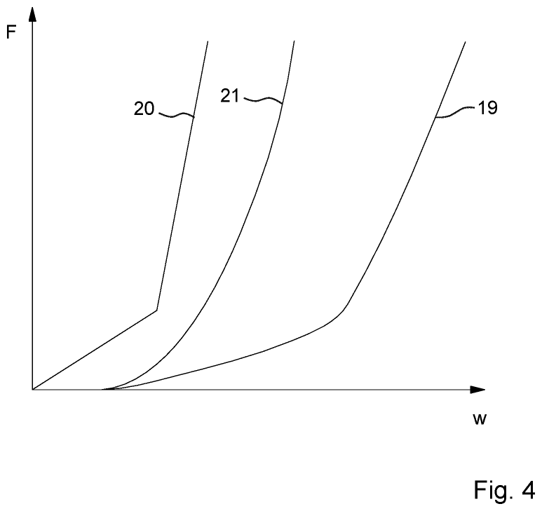

In FIG. 4, the influence of the spring means 14 on the behaviour of the pedal device 1 is illustrated in a schematic representation. In this case, the curve 19 represents a characteristic curve in which a pedal force F exerted on the pedal 2 is applied over a pedal path w travelled by the pedal 2 at the pedal device 1, which comprises both the at least one pedal spring 28 and the spring means 14. Additionally, curves 20 and 21 are shown, wherein curve 20 represents the characteristic curve of a pedal device with the at least one pedal spring 28, i.e. without spring means 14. Finally, the curve 21 represents the characteristic curve of a pedal device with the spring means 14 alone, i.e. without the at least one pedal spring 28. The pedal force F and the pedal path w extend in particular in the axial direction x. FIG. 4 relates in particular to the pedal device 1 according to the first embodiment. However, similar characteristic curves are observed for the other embodiments, so that FIG. 4 can also be referenced for explanatory purposes regarding the second and third embodiments.

### LIST OF REFERENCE NUMERALS

1 Pedal device
2 Pedal
3 Pedal body
4 Pedal cap
5 End of pedal body
6 Tread area of pedal cap
7 Pedal holder/housing
8 Flat spring
9 Flat spring
10 Pedal plate
11 Longitudinal axis
12 Position detection device
13 Cavity
14 Spring means
15 Wall area
16 Fastening area
17 Groove in fastening area projection
19 characteristic curve
20 characteristic curve
21 characteristic curve
22 elevation
23 Inner ring
24 Outer ring
25 Spring web
26 groove
27 groove
28 Pedal spring
E1 Spring plane
E2 Spring plane
F Pedal force
S Position signal
u Circumferential direction
w Pedal path
x Axial direction

1. A pedal device comprising:
a pedal having a pedal body and a pedal cap arranged at a pedal cap-side end of the pedal body, the pedal cap is provided with a tread area forming a free end of the pedal,
a pedal holder on which the pedal body is movably mounted in an axial direction,
at least one pedal spring coupled to the pedal holder and the pedal body, and the pedal body is configured to move against a spring force of the at least one pedal spring in the axial direction relative to the pedal holder, and
a spring means provided between the tread area and the pedal body, and the tread area is configured to move against a spring force of the spring means in the axial direction relative to the pedal body.

2. The pedal device according to claim 1, wherein the pedal cap is seated on a pedal plate provided on the pedal cap-side end of the pedal body and connected thereto.

3. The pedal device according to claim 2, wherein the spring means is provided between the tread area and the pedal plate.

4. The pedal device according to claim 1, wherein the pedal cap includes of a flexible material at least in areas.

5. The pedal device according to claim 4, wherein a cavity is formed in the pedal cap between the tread area and the pedal body, the spring means is located in the cavity.

6. The pedal device according to claim 5, wherein the spring means is formed by at least one solid body introduced into the cavity.

7. The pedal device according to claim 5, wherein the spring means is formed by a foam material introduced into the cavity.

8. The pedal device according to claim 5, wherein the spring means is formed by one or more flexible projections extending into the cavity, the one or more flexible projections are spaced apart from one another.

9. The pedal device according to claim 5, wherein the spring means is formed by gas trapped in the cavity.

10. The pedal device according to claim 5, wherein the pedal cap is provided with a wall region encircling the cavity, the wall region transitions at one axial end into the tread region and at another axial end into a fastening region, in which the pedal cap is fastened to the pedal body.

11. The pedal device according to claim 10, wherein at least one groove is provided on an inner side of the fastening region facing the pedal body, in which the pedal body engages at least indirectly.

12. The pedal device according to claim 1, wherein a position sensing device that detects a current axial position of the pedal body relative to the pedal holder, the position sensing device configured to provide at least one position signal characterising the current axial position.

13. The pedal device according to claim 1, wherein the at least one pedal spring has one or more flat springs aligned transversely to the axial direction, the one or more flat springs are penetrated by the pedal body and resiliently support the pedal body in the axial direction on the pedal holder.
